(19) United States
(12) Patent Application Publication
(10) Pub. No.: US 2026/0307095 A1
(43) Pub. Date: Oct. 8, 2026

(54) TREATMENT DEVICE

(71) Applicant: TOYOTA SHATAI KABUSHIKI KAISHA, Kariya-shi (JP)

(72) Inventors: Yasutaka NAKAMACHI, Aichi (JP); Kota TERAZOE, Aichi (JP); Yoshiteru ODA, Aichi (JP); Kaori OGASAWARA, Aichi (JP); Hiromitsu NIE, Aichi (JP); Tomohiro KAWAI, Aichi (JP)

(73) Assignee: TOYOTA SHATAI KABUSHIKI KAISHA, Kariya-shi (JP)

(21) Appl. No.: 19/143,217

(22) PCT Filed: Nov. 7, 2023
(86) PCT No.: PCT/JP2023/040002

§ 371 Date: Jun. 25, 2025

(30) Foreign Application Priority Data
Feb. 17, 2023 (JP) 2023-023454

(51) Int. Cl. B05B 14/45; B04C 1/00

(52) U.S. Cl. CPC B05B 14/45; B04C 1/00

(57) ABSTRACT

A treatment device for treating coating material mist, which is an object to be collected, includes a guide plate part formed in a spiral shape and having a swirl channel through which the coating material mist flows, and a cover part that covers the swirl channel of the guide plate part from a winding axis direction of the guide plate part, in which the swirl channel is provided with an inlet opening on an outer peripheral end side of the guide plate part, an outlet opening on an inner peripheral end side of the guide plate part, and a central space on a radially inner side of the outlet opening, and a swirl diameter of the swirl channel gradually decreases from the inlet opening to the outlet opening, and the cover part has a discharge port communicating with the central space of the swirl channel.

### TECHNICAL FIELD

The present disclosure relates to a treatment device that treats an object to be collected.

### BACKGROUND ART

Patent Literature 1 described below discloses a coating material mist remover. The coating material mist remover includes an intermediate filter for removing coating material mist as an object to be collected. In this coating material mist remover, as the intermediate filter, one in which a plurality of obstacle walls bent in a triangular wave shape are arranged inside a housing, one in which columnar supports with an angular groove structure or a V-shape structure are arranged in a staggered manner inside a housing, one in which columnar supports with a V-shape structure are arranged in a staggered manner inside a housing, or the like is used. The coating material mist contained in the air is removed by colliding with and adhering to the surfaces of the obstacle walls and the columnar supports when flowing inside the housing of the intermediate filter.

Patent Literature 2 described below discloses a coating material collection device. The coating material collection device includes a cyclone container having a large-diameter cylindrical portion, a small-diameter cylindrical portion, and a conical cylindrical portion between the large-diameter cylindrical portion and the small-diameter cylindrical portion. The coating material mist as the object to be collected flows from an intake pipe of the large-diameter cylindrical portion of the cyclone container and then flows from the large-diameter cylindrical portion side toward a collection pipe of the small-diameter cylindrical portion while swirling inside the cyclone container. The coating material is centrifuged by the swirling flow at this time, and the coating material after the centrifugation is collected from the cyclone container through the collection pipe. Further, the air after the centrifugation flows in the opposite direction from the small-diameter cylindrical portion side of the cyclone container toward an exhaust pipe of the large-diameter cylindrical portion, and then is exhausted from the cyclone container through the exhaust pipe.

### PRIOR ART LITERATURE

### Patent Literature

Patent Literature 1: JP 2021-580 A

### SUMMARY OF INVENTION

### Problems to be Solved by Invention

The coating material mist remover of Patent Literature 1 utilizes a structure in which coating material mist is simply caused to collide with a surface of an obstacle wall or a columnar support of an intermediate filter to be attached thereto. For this reason, the coating material mist remover has the problem that the collection efficiency of the coating material mist is low. On the other hand, the coating material collection device of Patent Literature 2 can enhance the collection efficiency of the coating material mist as compared with the coating material mist remover of Patent Literature 1, but has the problem that it is difficult to suppress the pressure loss to a low level. That is, in this coating material collection device, the air flowing into the cyclone container flows while swirling from the large-diameter cylindrical portion side to the small-diameter cylindrical portion side, and then is reversed on the small-diameter cylindrical portion side and flows in the opposite direction to the large-diameter cylindrical portion side. In this manner, the pressure loss increases due to the structure involving the reverse flow of air inside the cyclone container.

The present disclosure has been made in view of such problems, and an object of the present disclosure is to provide a treatment device capable of achieving both improvement in collection efficiency of an object to be collected and reduction in pressure loss.

### Means for Solving Problem

One aspect of the present disclosure is
a treatment device for treating an object to be collected,
the treatment device including:
a guide plate part formed in a spiral shape and having a swirl channel through which the object to be collected flows; and
a cover part that covers the swirl channel of the guide plate part from a winding axis direction of the guide plate part,
wherein the swirl channel is provided with an inlet opening on an outer peripheral end side of the guide plate part, an outlet opening on an inner peripheral end side of the guide plate part, and a central space on a radially inner side of the outlet opening, and a swirl diameter of the swirl channel gradually decreases from the inlet opening to the outlet opening, and
the cover part has a discharge port communicating with the central space of the swirl channel.

### Effects of Invention

According to the treatment device of the above-described aspect, the object to be collected flows through the swirl channel of the guide plate part formed in a spiral shape from the inlet opening toward the outlet opening. At this time, since the swirl diameter of the swirl channel gradually decreases from the inlet opening to the outlet opening, the centrifugal force acting on the object to be collected can be gradually increased toward the outlet opening. By using the centrifugal force at this time to attach and collect the object to be collected on the surface of the guide plate part, the collection efficiency of the object to be collected can be improved.

In addition, by selectively collecting coarse particles using a relatively weak centrifugal force near the inlet opening of the swirl channel, it is possible to prevent the object to be collected having a wide range of particle diameters from being deposited and clogged near the inlet opening. On the other hand, near the outlet opening of the swirl channel, it is possible to ultimately and reliably collect the fine particles that could not be captured upstream by using strong centrifugal force. As a result, it is possible to prevent the pressure loss from increasing due to the deposition of the object to be collected. In addition, since the pressure loss can be reduced, the treatment air volume of the object to be collected can be increased.

According to the above aspect, it is possible to provide a treatment device capable of achieving both improvement in collection efficiency of an object to be collected and reduction in pressure loss.

### BRIEF DESCRIPTION OF DRAWINGS

The above described object and other objects, features, and advantages of the present disclosure will become more apparent from the following detailed description with reference to the accompanying drawings. The drawings are as follows.

FIG. 1 is an overall view of a coating booth according to a first embodiment.

FIG. 2 is a perspective view of the treatment device according to the first embodiment.

FIG. 3 is a radial cross-sectional view of a guide plate part of the treatment device of FIG. 2.

FIG. 4 is a cross-sectional view illustrating the guide plate part of FIG. 3 in a state where coating material mist is collected.

FIG. 5 is a view showing a particle size distribution of the coating material mist.

FIG. 6 is a perspective view illustrating the guide plate part in an unfolded state.

FIG. 7 is a graph showing the correlation between the number of turns of the guide plate part and each of the collection efficiency and the pressure loss.

FIG. 8 is a diagram for explaining structural features of the guide plate part belonging to a high-performance region of the graph of FIG. 7.

FIG. 9 is an overall view of a coating booth having another embodiment different from the coating booth of FIG. 1.

### MODE FOR CARRYING OUT INVENTION

Preferred embodiments of the above-described aspects will be described below.

It is preferable in the treatment device according to the above-described aspect that the guide plate part is configured such that the swirl channel has a spiral pitch which gradually decreases in a radial direction of the guide plate part from the inlet opening to the outlet opening. According to this treatment device, by gradually decreasing the spiral pitch of the swirl channel from the inlet opening to the outlet opening, the flow velocity of the object to be collected increases from the inlet opening toward the outlet opening. As the flow velocity increases at this time, the effect of increasing the centrifugal force acting on the object to be collected increases. As a result, the collection efficiency of the object to be collected can be further improved.

It is preferable in the treatment device according to the above-described aspect that the guide plate part is configured such that an opening diameter of the central space of the swirl channel substantially coincide with an opening diameter of the discharge port. According to this treatment device, by making the opening diameter of the central space of the swirl channel substantially coincide with the opening diameter of the discharge port, a smooth flow can be formed from the central space toward the discharge port. As a result, the pressure loss can be further reduced.

It is preferable in the treatment device according to the above-described aspect that the guide plate part has a convexo-concave portion on a surface defining the swirl channel According to this treatment device, by providing the convexo-concave portion on the surface of the guide plate part, immediately after the start of use, the object to be collected can be deposited and collected in the concave portion while blocking the flow of a part of the object to be collected by the convex portion of the convexo-concave portion. Thereafter, as the collection of the object to be collected progresses, the convexo-concave portion becomes a substantially flat surface, so that the pressure loss can be kept constant.

It is preferable that the treatment device according to the above-described aspect includes a main body case that accommodates the plurality of guide plate parts, and the main body case is provided with a suction pipe and a discharge pipe that are shared by the plurality of guide plate parts. According to this treatment device, it is possible to unitize a plurality of guide plate parts in the main body case by arranging the guide plate parts appropriately side by side or by overlapping the guide plate parts. The object to be collected can be supplied to any of the plurality of guide plate parts through the intake pipe of the main body case, and the air after the collection treatment of the object to be collected is performed in each of the plurality of guide plate parts can be exhausted through the exhaust pipe of the main body case.

Hereinafter, an embodiment of a treatment device provided in a coating booth will be described with reference to the drawings.

In the drawings for describing the embodiment, unless otherwise specified, the winding axis direction of the guide plate part constituting the treatment device is indicated by an arrow X, the radial direction of the guide plate part is indicated by an arrow Y, and the circumferential direction of the guide plate part is indicated by an arrow Z.

### FIRST EMBODIMENT

### 1. Overall Structure of Coating Booth 1

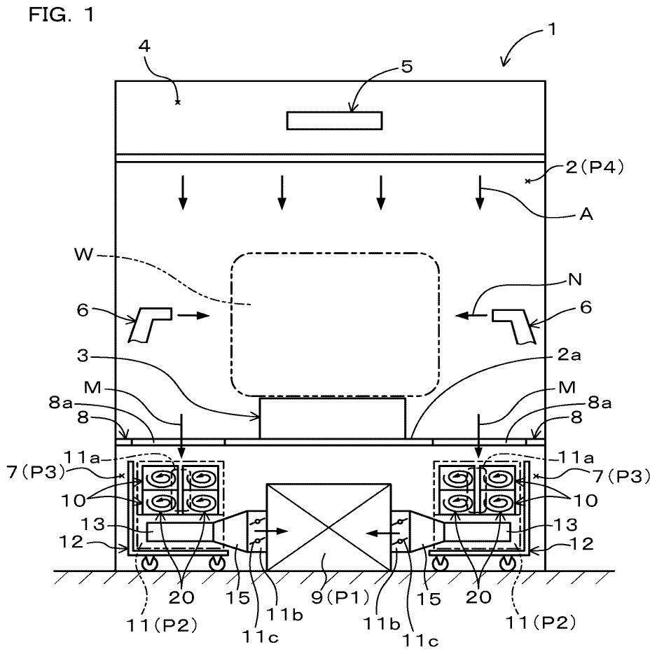

As illustrated in FIG. 1, a coating booth 1 according to a first embodiment is used, for example, for spray coating of a workpiece W which is an automobile body. The coating booth 1 is provided with a coating chamber 2, an air supply chamber 4, and a baffle chamber 7. The air supply chamber 4 is disposed above the coating chamber 2, and the baffle chamber 7 is disposed below the coating chamber 2.

The coating chamber 2 has a coating treatment space into and from which the workpiece W can be introduced and discharged by a conveyance device 3. The coating chamber 2 is provided with a plurality of coating nozzles 6 for spraying a coating material N from laterally toward the workpiece W introduced into the coating treatment space. The coating material N sprayed from each coating nozzle 6 is applied to the workpiece W according to the compressed air jetted from the coating nozzle 6.

The air supply chamber 4 is provided with an air conditioner (not illustrated) for creating air A whose temperature and humidity have been adjusted, and an air supply fan 5 that sucks and discharges the air A. The air A discharged from the air supply fan 5 forms a downward flow flowing downward toward the coating chamber 2. Therefore, the coating material N that has not been applied to the workpiece W in the coating chamber 2 flows downward as spray-like coating material mist M according to the downward flow of the air A. The coating material mist M is a liquid molecule of the coating material N floating in the air A. In the present embodiment, the coating material mist M is used as an object to be collected.

A partition wall portion 8 constituting a floor surface 2a of the coating chamber 2 is provided between the coating chamber 2 and the baffle chamber 7. The baffle chamber 7 functions as a relay part that sends the coating material mist M to a suction pipe 11a of a main body case 11 described later and functions to preliminarily collect the coating material mist M. The partition wall portion 8 has a communication hole 8a for allowing the coating material mist M generated in the coating chamber 2 to flow into the baffle chamber 7. Therefore, the baffle chamber 7 communicates with the coating chamber 2 only through the communication hole 8a provided through the partition wall portion 8. The baffle chamber 7 is not limited to a room shape, and may have a duct shape that relays the coating material mist M.

### 2. Structure of Treatment Device 10

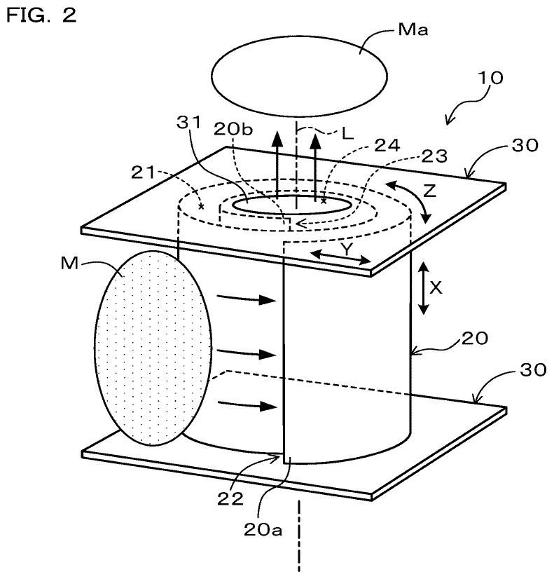

A treatment device 10 of the first embodiment is disposed under the floor of the coating chamber 2 and is replaced as appropriate. The treatment device 10 is for treating the coating material mist M, which is an object to be collected, and includes a guide plate part 20. The treatment device 10 is stored in the main body case 11 which is a housing. In a state where the treatment device 10 is stored in the main body case 11, the guide plate part 20 is disposed in a vertical arrangement such that the winding axis direction X (see FIG. 2) extends along the vertical direction. When the guide plate part 20 is disposed vertically, it is also effective to collect such coating material that has low adhesiveness and is easily collapsed.

Although FIG. 1 illustrates a case where four treatment devices 10 are stored in the main body case 11, the number of treatment devices 10 is not particularly limited. Only one treatment device 10 may be stored in the main body case 11, or a plurality of treatment devices 10 may be appropriately arranged or stacked in the main body case 11 to be unitized and stored.

The main body case 11 is carried by a movable cart 12. An operator can attach and detach the treatment device 10 in a state where the main body case 11 is placed on the cart 12. Therefore, it is effective to reduce the work load required for replacement and maintenance of the treatment device 10. In addition, even when the treatment device 10 becomes heavy due to coating material collection, it can be easily carried out using the cart 12.

In a state where the main body case 11 is carried into a setting position by the cart 12, a filter member 13 is disposed below the treatment device 10. The filter member 13 is connected to an exhaust duct 9 via a coupling portion 15 and a discharge pipe 11b. The filter member 13 is a cylindrical secondary filter for collecting the coating material remaining after the treatment of the treatment device 10. The discharge pipe 11b is for discharging the air treated by the filter member 13 to the exhaust duct 9. It is preferable that a damper 11c for air volume adjustment is provided inside the discharge pipe 11b.

The main body case 11 is provided with the suction pipe 11a into which the coating material mist M flows. In the present embodiment, one suction pipe 11a is shared by the four treatment devices 10. An exhaust fan (not illustrated) is connected to the exhaust duct 9. Therefore, when the exhaust fan is in operation, the coating material mist M supplied to the guide plate parts 20 of the respective treatment devices 10 through the suction pipe 11a of the main body case 11 is subjected to the collection treatment by the respective guide plate parts 20, and then exhausted to the exhaust duct 9 through the filter member 13, the coupling portion 15, and the discharge pipe 11b. As a result, the coating material mist M can be treated by the guide plate part 20, and further treated by the filter member 13 following the guide plate part 20. The main body case 11 can be reused instead of being disposed of.

In the present embodiment, as illustrated in FIG. 1, when the pressure of the exhaust duct 9 is P1, the pressure inside the main body case 11 is P2, the pressure of the baffle chamber 7 is P3, and the pressure of the coating chamber 2 is P4, a relationship of P4>P3>P2>P1 is established for these pressure balances. In FIG. 1, reference numeral 9 (P1) indicates that the pressure of the exhaust duct 9 is P1, reference numeral 11 (P2) indicates that the pressure of the main body case 11 is P2, reference numeral 7 (P3) indicates that the pressure of the baffle chamber 7 is P3, and reference numeral 2 (P4) indicates that the pressure of the coating chamber 2 is P4.

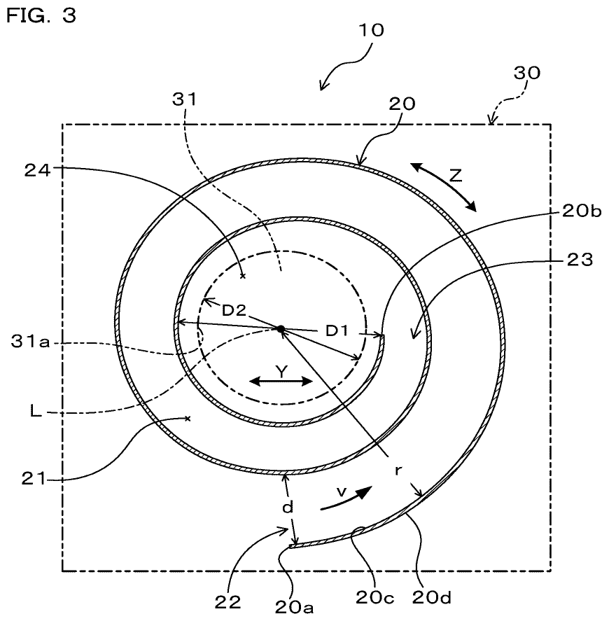

Next, a detailed structure of the treatment device 10 of the present embodiment will be described with reference to FIGS. 2 and 3. Since the plurality of guide plate parts 20 have the same structure, the structure of only one guide plate part 20 will be described below.

As illustrated in FIG. 2, the treatment device 10 includes two cover parts 30 in addition to the guide plate part 20. The guide plate part 20 is formed in a spiral shape from an outer peripheral end 20a to an inner peripheral end 20b around a virtual central axis L. The guide plate part 20 is formed by spirally rolling a plate-shaped member having a constant width dimension in the winding axis direction X, and includes a swirl channel 21 through which the coating material mist M flows. The swirl channel 21 is provided with an inlet opening 22 on the outer peripheral end 20a side of the guide plate part 20, an outlet opening 23 on the inner peripheral end 20b side of the guide plate part 20, and a central space 24 inside the outlet opening 23 in the radial direction Y. The central space 24 is formed to have a substantially circular shape when viewed in the winding axis direction X. Such a guide plate part 20 is also referred to as a “spiral cyclone”.

The two cover parts 30 have a function of covering the swirl channel 21 of the guide plate part 20 from the winding axis direction X of the guide plate part 20. At least one of the two cover parts 30 is provided with a circular discharge port 31 communicating with the central space 24 of the swirl channel 21. A suction action by the exhaust fan of the exhaust duct 9 is imparted to the discharge port 31. As a result, in the swirl channel 21 of the guide plate part 20, a swirling flow by the coating material mist M is formed from the inlet opening 22 to the outlet opening 23 according to a spiral channel shape.

A part of the coating material mist M is collected when flowing through the swirl channel 21, and air Ma after the collection treatment is discharged from the central space 24 of the swirl channel 21 to the outside of the treatment device 10 through the discharge port 31 of the cover part 30. When the air Ma moves from the central space 24 of the swirl channel 21 to the discharge port 31, the flow of the air Ma changes direction by approximately 90°.

### 3. Structure of Guide Plate Part 20

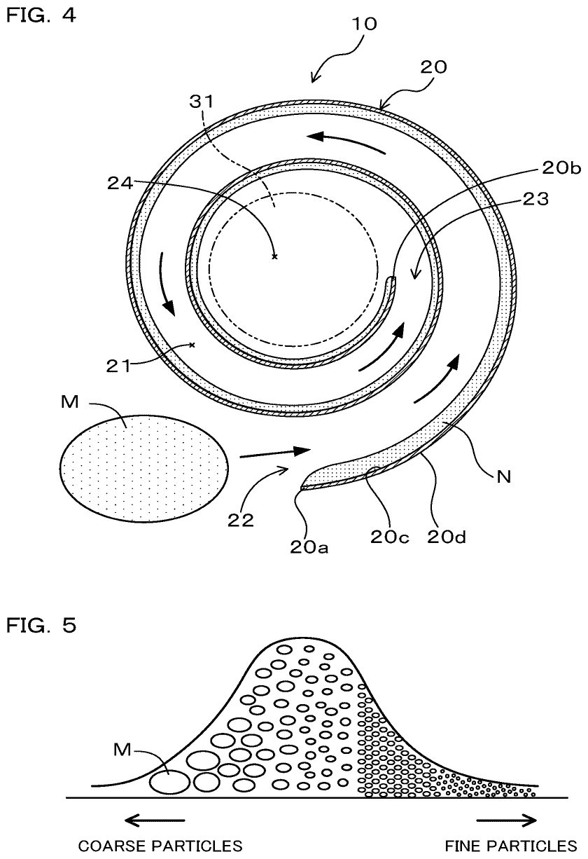

As illustrated in FIG. 3, the swirl channel 21 of the guide plate part 20 is a channel having the inlet opening 22 as an inlet. The guide plate part 20 is configured such that a swirl diameter r (position in the radial direction Y from the central axis L) of an outer edge portion of the swirl channel 21 gradually decreases from the inlet opening 22 to the outlet opening 23. The swirl channel 21 has a channel width indicated by a spiral pitch d in the radial direction Y. When the coating material mist M flows through the swirl channel 21 from the inlet opening 22 toward the outlet opening 23, the centrifugal force acts on the coating material mist M due to the swirling effect. When the flow velocity of the coating material mist M is denoted by v and the centrifugal force acting on the coating material mist M is denoted by F, the centrifugal force F is expressed by the following Equation (1). According to Equation (1), the centrifugal force F increases as the swirl diameter r gradually decreases from the inlet opening 22 toward the outlet opening 23. The coating material mist M is collected using the centrifugal force F at this time. Specifically, as illustrated in FIG. 4, the coating material mist M can be attached to a surface 20c of the guide plate part 20 and collected as the coating material N.

$$F = {v}^{2} / r \qquad ( 1 )$$

According to Equation (1), the centrifugal force F acting on the coating material mist M increases as the swirl diameter r gradually decreases from the inlet opening 22 toward the outlet opening 23 of the swirl channel 21. For example, in a case where the flow velocity v of the coating material mist M is constant and the swirl diameter r in the outlet opening 23 is half the inlet opening 22 side, when the coating material mist M swirls from the inlet opening 22 to the outlet opening 23, the centrifugal force F increases to twice that on the inlet opening 22 side.

Here, when the particle size distribution of the coating material mist M is, for example, as illustrated in FIG. 5, the coarse particles having a relatively large particle diameter can be collected even with a relatively weak centrifugal force F, while fine particles having a relatively small particle diameter require a strong centrifugal force F to be collected. When the centrifugal force F is increased over the entire swirl channel 21 in consideration of collecting fine particles, the coating material is deposited and easily clogged near the inlet opening 22 of the swirl channel 21 regardless of the particle diameter. This increases the pressure loss. However, when the centrifugal force F is weakened over the entire swirl channel 21 in order to avoid the deposition of the coating material near the inlet opening 22 of the swirl channel 21, the collection efficiency of the coating material mist M is reduced in this case.

Therefore, the guide plate part 20 of the present embodiment employs a structure in which the centrifugal force F acting on the coating material mist M increases from the inlet opening 22 toward the outlet opening 23 of the swirl channel 21. According to the present structure, the centrifugal force F can be minimized on the inlet opening 22 side of the swirl channel 21 and maximized on the outlet opening 23 side of the swirl channel 21. As a result, by selectively collecting the coarse particles using a relatively weak centrifugal force F near the inlet opening 22 of the swirl channel 21, it is possible to prevent the coating material mist M having a wide range of particle diameters from being deposited and clogged near the inlet opening 22. On the other hand, near the outlet opening 23 of the swirl channel 21, it is possible to ultimately and reliably collect the fine particles that could not be captured upstream by using strong centrifugal force F. As a result, it is possible to prevent the pressure loss from increasing due to the deposition of the coating material mist M. In addition, since the pressure loss can be reduced, the treatment air volume of the coating material mist M can be increased.

### 4. Surface Structure of Guide Plate Part 20

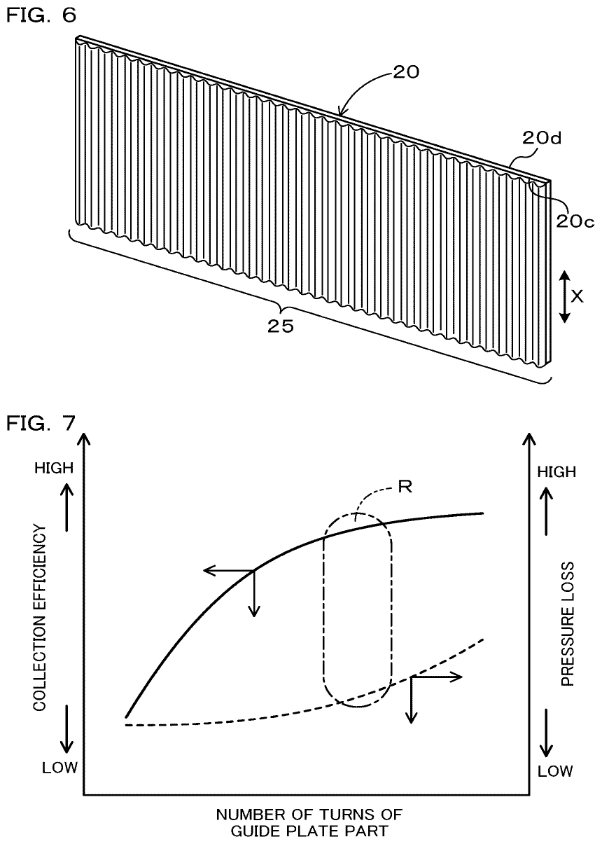

The guide plate part 20 illustrated in FIG. 6 is in an unfolded state in which the guide plate part 20 is spread in a flat shape. As described above, it is preferable that the guide plate part 20 of the present embodiment has a convexo-concave portion 25 on one surface 20c of the two surfaces 20c and 20d that define the swirl channel 21. The convexo-concave portion 25 has a wave shape formed so as to partially block the flow of the coating material mist M, and is configured such that both a wave top line and a wave bottom line extend in the winding axis direction X. By providing the convexo-concave portion 25 on the surface 20c of the guide plate part 20, immediately after the start of use, the coating material mist M can be deposited and collected in the concave portion while blocking the flow of a part of the coating material mist M by the convex portion of the convexo-concave portion 25. Thereafter, as the collection of the coating material mist M progresses, the convexo-concave portion 25 becomes a substantially flat surface, so that the pressure loss can be kept constant.

For preparing the guide plate part 20, for example, single-faced corrugated cardboard which is a burnable member can be used. The guide plate part 20 can be prepared by spirally rolling the single-faced corrugated cardboard in the unfolded state. In this case, the wave shape already provided on one surface of the single-faced corrugated cardboard can be used for the convexo-concave portion 25. When the single-faced corrugated cardboard is used, the cost required for the guide plate part 20 can be suppressed low. The convexo-concave portions 25 may be provided on both surfaces of the two surfaces 20c and 20d of the guide plate part 20, as necessary.

Instead of the corrugated convexo-concave portion 25, for example, a convexo-concave portion including a plurality of protrusions can be adopted. Further, instead of or in addition to using the corrugated convexo-concave portion 25, a structure subjected to coating treatment with a material having high affinity with the coating material mist M can also be adopted. When the collection efficiency of the coating material mist M is at a desired level, the surface 20c of the guide plate part 20 may be a flat surface having no convexo-concave portion.

### 5. Performance Evaluation of Treatment Device 10

Here, performance evaluation when the treatment device 10 is actually used will be described. In this performance evaluation, the collection efficiency and the pressure loss of the coating material mist M were evaluated when preset structural parameters were appropriately changed. As the structural parameters at this time, the number of turns of the guide plate part 20, the spiral pitch d of the guide plate part 20, the opening diameter D1 (a case where the shape of the central space 24 when viewed from the winding axis direction X is circular for convenience) of the central space 24 of the swirl channel 21, the opening diameter D2 of the discharge port 31, and the like are adopted (see FIG. 3).

As shown in the graph of FIG. 7, as a result of the performance evaluation, it has been confirmed that the collection efficiency of the coating material mist M increases as the number of turns of the guide plate part 20 increases. This is because, as the number of turns of the guide plate part 20 increases, a collection area for collecting the coating material mist M increases, that is, the length of the swirl channel 21 increases. Similarly, as a result of the performance evaluation, it has been confirmed that the pressure loss decreases as the number of turns of the guide plate part 20 is reduced. This is because, as the number of turns of the guide plate part 20 is smaller, the resistance that the coating material mist M receives from the guide plate part 20 can be reduced. Based on the graph of FIG. 7, when the number of turns of the guide plate part 20 is set within a predetermined range, it is possible to obtain a high-performance region R in which both the improvement in the collection efficiency of the coating material mist M and the reduction in the pressure loss can be achieved by optimizing the structural parameters.

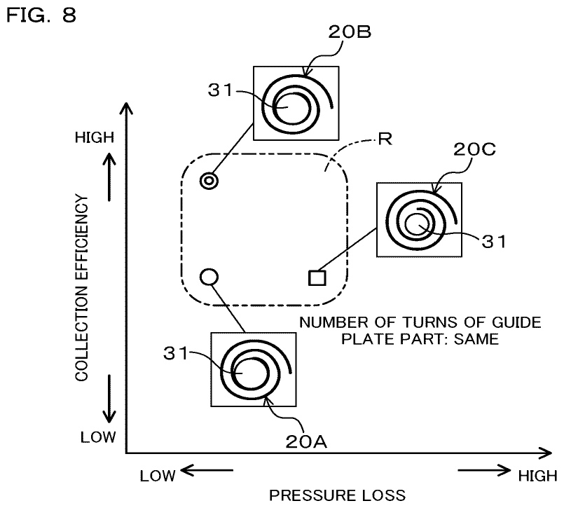

Here, structural features of the guide plate part 20 belonging to the high-performance region R in FIG. 7 will be described with reference to FIGS. 3 and 8. In FIG. 8, three guide plate parts 20 (first guide plate part 20A, second guide plate part 20B, and third guide plate part 20C) belonging to the high-performance region R are illustrated. The numbers of turns of these three guide plate parts 20 are the same.

As illustrated in FIG. 8, the first guide plate part 20A is configured such that the spiral pitch d (see FIG. 3) is constant from the inlet opening 22 to the outlet opening 23 of the swirl channel 21. The first guide plate part 20A is configured such that the opening diameter D1 (see FIG. 3) of the central space 24 of the swirl channel 21 substantially coincides with the opening diameter D2 (see FIG. 3) of the discharge port 31. That is, when the first guide plate part 20A is viewed from the winding axis direction X, the surface 20c defining the central space 24 extends so as to overlap an opening edge 31a (see FIG. 3) of the discharge port 31. The correlation between the collection efficiency and the pressure loss when the first guide plate part 20A is used is shown by a circle-shaped plot in FIG. 8.

The second guide plate part 20B is configured such that the spiral pitch d in the radial direction Y of the swirl channel 21 gradually decreases from the inlet opening 22 to the outlet opening 23. Similarly to the first guide plate part 20A, the second guide plate part 20B is configured such that the opening diameter D1 of the central space 24 of the swirl channel 21 substantially coincides with the opening diameter D2 of the discharge port 31. The correlation between the collection efficiency and the pressure loss when the second guide plate part 20B is used is shown by a double circle-shaped plot in FIG. 8. The second guide plate part 20B is most excellent in the effect of achieving both the improvement in the collection efficiency and the reduction in the pressure loss among the three guide plate parts 20.

When the second guide plate part 20B is used, the collection efficiency of the coating material mist M is increased as compared with the case where the first guide plate part 20A is used. This is because the spiral pitch d of the swirl channel 21 is gradually decreased from the inlet opening 22 to the outlet opening 23. That is, by gradually decreasing the spiral pitch d from the inlet opening to the outlet opening, the flow velocity v of the coating material mist M increases from the inlet opening 22 toward the outlet opening 23. As the flow velocity increases at this time, the effect of increasing the centrifugal force F acting on the coating material mist M increases. As a result, the collection efficiency of the coating material mist M can be further improved.

For example, when Equation (1) described above is applied, in a case where the spiral pitch d in the outlet opening 23 is a half of that on the inlet opening 22 side, the flow velocity v of the coating material mist M becomes two times. Therefore, when the coating material mist M swirls from the inlet opening 22 to the outlet opening 23, the centrifugal force F increases to eight times that on the inlet opening 22 side. It is presumed that as a result, the collection efficiency of the coating material mist M has increased.

When the second guide plate part 20B is used, a smooth flow can be formed from the central space 24 toward the discharge port 31 by making the opening diameter D1 of the central space 24 of the swirl channel 21 substantially coincide with the opening diameter D2 of the discharge port 31. As a result, the pressure loss can be further reduced.

Similarly to the first guide plate part 20A, the third guide plate part 20C is configured such that the spiral pitch d is constant from the inlet opening 22 to the outlet opening 23 of the swirl channel 21. The third guide plate part 20C is configured such that the opening diameter D1 of the central space 24 of the swirl channel 21 exceeds the opening diameter D2 of the discharge port 31. The correlation between the collection efficiency and the pressure loss when the third guide plate part 20C is used is shown by a square-shaped plot in FIG. 8.

When the third guide plate part 20C is used, the pressure loss increases as compared with the case where the first guide plate part 20A is used. This is because the opening diameter D1 of the central space 24 is larger than the opening diameter D2 of the discharge port 31. As compared with the case where the opening diameter D1 is made to substantially coincide with the opening diameter D2, it is presumed that a smooth flow is less likely to be formed from the central space 24 toward the discharge port 31, and the pressure loss increases accordingly. In order to prevent the pressure loss from increasing too much, it is preferable that the inner peripheral end 20b (see FIG. 3) of the third guide plate part 20C is configured to be close to the opening edge 31a (see FIG. 3) of the discharge port 31 to less than 10% of the opening diameter D2.

As described above, according to the first embodiment, it is possible to provide the treatment device 10 capable of achieving both improvement in collection efficiency of the coating material mist M, which is an object to be collected, and reduction in pressure loss.

According to the treatment device 10 of the first embodiment, it is possible to perform processing with high collection performance in a space-saving manner by downsizing the guide plate part 20. Since the treatment device 10 uses the guide plate part 20 having a simple structure, it is effective to suppress the device cost to be low.

Since the treatment device 10 of the first embodiment is excellent in the effect of reducing the pressure loss, clogging of the object to be collected is less likely to occur, and the treatment can be continued for a long period of time. In addition, since the treatment device 10 is excellent in the effect of reducing the pressure loss, it is possible to reduce the energy cost required for the equipment used to supply and exhaust air, and it is possible to reduce the amount of carbon dioxide discharged from the equipment.

### 6. Coating Booth of Another Embodiment

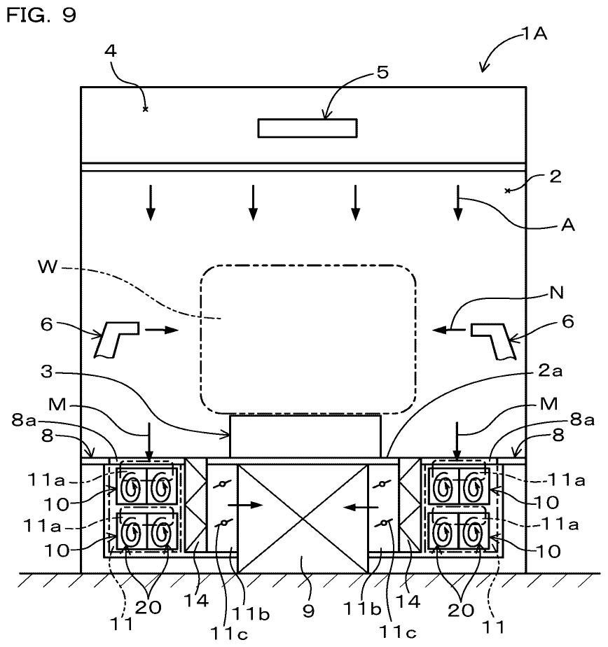

Next, a coating booth 1A of a different embodiment from the coating booth 1 of FIG. 1 will be described with reference to FIG. 9. The coating booth 1A is different from the coating booth 1 of the first embodiment in the underfloor structure of the coating chamber 2 and the arrangement structure of the treatment devices 10. Other structures are the same as those of the coating booth 1. In FIG. 9, the same elements as those illustrated in FIG. 1 are denoted by the same reference numerals, and the description of the same elements will be omitted below.

In the coating booth 1A, a space accessible from above the floor is provided under the floor of the coating chamber 2, and the treatment device 10 is disposed in this space in a state of being stored in the main body case 11. Therefore, the operator can attach and detach the treatment device 10 from above the floor of the coating chamber 2. In a state where the treatment device 10 is stored in the main body case 11, the guide plate part 20 is disposed in a horizontal arrangement such that the winding axis direction X (see FIG. 2) extends along the horizontal direction. When the guide plate part 20 is disposed horizontally, it is also effective to collect such coating material that has high adhesiveness and is less likely to be collapsed.

A filter member 14 is disposed on the side of the treatment device 10. The filter member 14 is connected to the exhaust duct 9 via the discharge pipe 11b. The filter member 14 is a wave-shaped secondary filter for collecting the coating material remaining after the treatment of the treatment device 10. The coating material mist M supplied to the guide plate parts 20 of the respective treatment devices 10 through the suction pipe 11a of the main body case 11 is subjected to the collection treatment by the respective guide plate parts 20, and then exhausted to the exhaust duct 9 through the filter member 14 and the discharge pipe 11b. In the present embodiment, each of the two suction pipes 11a is shared by the two treatment devices 10. The main body case 11 can be reused instead of being disposed of.

The coating booth 1A is not provided with a relay part like the baffle chamber 7 of the coating booth 1. Therefore, an area to be cleaned can be reduced by omitting the relay part, and the number of man-hours required for cleaning can be reduced accordingly.

Although the present disclosure has been described in accordance with the above-described embodiments, it is understood that the present disclosure is not limited to such embodiments and structures. The present disclosure also includes various modified examples and modifications within an equivalent range. In addition, various combinations and modes, and other combinations and modes including only one element, more elements, or less elements are also within the scope and idea of the present disclosure. For example, the following embodiments to which the above-described embodiments are applied can be implemented.

In the above-described embodiments, the treatment device 10 used in a coating facility of an automobile body has been exemplified, but the treatment device 10 can also be applied to a coating facility in a field other than automobiles, as necessary.

In the above-described embodiments, the treatment device 10 for treating the coating material mist M by using the coating material mist M contained in the air as the object to be collected has been exemplified, but the object to be collected is not limited to only the coating material mist M, and other objects to be collected may be treated by the treatment device 10. Various substances contained in a gas or a liquid can be used as the object to be collected.

1. A treatment device for treating an object to be collected,
the treatment device comprising:
a guide plate part formed in a spiral shape and having a swirl channel through which the object to be collected flows; and
a cover part that covers the swirl channel of the guide plate part from a winding axis direction of the guide plate part,
wherein the swirl channel is provided with an inlet opening on an outer peripheral end side of the guide plate part, an outlet opening on an inner peripheral end side of the guide plate part, and a central space on a radially inner side of the outlet opening, and a swirl diameter of the swirl channel gradually decreases from the inlet opening to the outlet opening, and
the cover part has a discharge port communicating with the central space of the swirl channel.

2. The treatment device according to claim 1, wherein the guide plate part is configured such that the swirl channel has a spiral pitch which gradually decreases in a radial direction of the guide plate part from the inlet opening to the outlet opening.

3. The treatment device according to claim 1, wherein the guide plate part is configured such that an opening diameter of the central space of the swirl channel substantially coincides with an opening diameter of the discharge port.

4. The treatment device according to claim 1, wherein the guide plate part has a convexo-concave portion on a surface defining the swirl channel.

5. The treatment device according to claim 1, further comprising a main body case that accommodates a plurality of the guide plate parts, wherein the main body case is provided with a suction pipe and a discharge pipe that are shared by the plurality of the guide plate parts.
